(19) United States
(12) Patent Application Publication
(10) Pub. No.: US 2018/0330405 A1
(43) Pub. Date: Nov. 15, 2018

(54) AUCTIONING PROMOTIONAL ITEM AFFILIATION

(71) Applicant: GOOGLE INC., Mountain View, CA (US)

(72) Inventors: Malik Ashiru, New York, NY (US); Spencer Spinnell, New York, NY (US)

(73) Assignee: GOOGLE INC., Mountain View, CA (US)

(21) Appl. No.: 14/095,985

(22) Filed: Dec. 3, 2013

(51) Int. Cl. G06Q 30/02

(52) U.S. Cl. CPC G06Q 30/0275

(57) ABSTRACT

Receiving bids for an online promotion opportunity to present promotional content. Each bid for the online promotion opportunity being associated with one of a set of primary bidders. Awarding the online promotion opportunity to a primary bidder from the set of primary bidders. Receiving at least one bid for affiliation with the awarded online promotion opportunity. Each bid for affiliation being associated with one of a set of secondary bidders. Awarding affiliation with the awarded online promotion opportunity to a secondary bidder from the set of secondary bidders. Transmitting the promotional content of the awarded primary bidder as affiliated with the awarded secondary bidder, and as an impression to a consumer during the online promotion opportunity.

### FIELD OF THE TECHNOLOGY

The disclosed technology relates to online marketing generally. Example embodiments relate to auctioning affiliation with promotional content.

### BACKGROUND

In typical online advertising, including desktop and mobile advertising, an ad, an offer, a coupon, or any type of promotion (hereinafter also referred to as “promotional content”) may be transmitted to a consumer via a consumer computing device and is typically referred to as an impression.

Consumer Packaged Goods (CPG) are products that are typically consumed quickly or replaced frequently. Examples include non-durable goods such as soft drinks, toiletries, and grocery items. CPGs are often the subject of online advertising in the form of offers or coupons. It is common for a CPG manufacturer, producer, or supplier (referred to hereinafter as “manufacturer”) to offer a coupon as part of an CPG online advertising campaign that is co-branded with one or more retailers that stock the CPG. It is also common to run such a campaign without retailer cobranding.

### BRIEF DESCRIPTION OF THE DRAWINGS

FIG. 1 is a diagram depicting a communications and processing architecture for auctioning promotional item affiliation, in accordance with certain example embodiments.

FIG. 2 is a diagram depicting methods for auctioning promotional item affiliation in accordance with certain example embodiments of the present technology.

FIG. 3 is a diagram depicting an example user interface for auctioning promotional item affiliation in accordance with certain example embodiments of the present technology.

FIG. 4 is a diagram depicting example promotional items associated with auctioning promotional item affiliation in accordance with certain example embodiments of the present technology.

FIG. 5 is a diagram depicting methods for auctioning promotional item affiliation in accordance with certain example embodiments of the present technology.

FIG. 6 is a diagram depicting methods for auctioning promotional item affiliation in accordance with certain example embodiments of the present technology.

FIG. 7 is a diagram depicting methods for auctioning promotional item affiliation in accordance with certain example embodiments of the present technology.

FIG. 8 is a diagram depicting methods for auctioning promotional item affiliation in accordance with certain example embodiments of the present technology.

FIG. 9 is a diagram depicting methods for auctioning promotional item affiliation in accordance with certain example embodiments of the present technology.

FIG. 10 is a block diagram depicting a computing machine and a module, in accordance with certain example embodiments.

### SUMMARY

The technology described herein includes computer-implemented methods, computer program products, and systems for auctioning promotional item affiliation.

In some embodiments, the technology can receive bids for an online promotion opportunity to presresentent promotional content. Each bid for the online promotion opportunity being associated with one of a set of primary bidders. The online promotion opportunity can be awarded to a primary bidder from the set of primary bidders. Bids for affiliation with the awarded online promotion opportunity can be received. Each bid for affiliation being associated with one of a set of secondary bidders. Affiliation with the awarded online promotion opportunity can be awarded to a secondary bidder from the set of secondary bidders. The promotional content of the awarded primary bidder as affiliated with the awarded secondary bidder, can be transmitted as an impression to a consumer during the online promotion opportunity.

In some embodiments, each primary bidder is a consumer package goods (CPG) manufacturer, the promotional content of the awarded primary bidder is an offer for CPG; and each secondary bidder is a retailer offering the CPG. In some such embodiments, input can be received from the consumer to save the offer, and the saved offer can be associated with the retailer and the consumer in an account of the consumer. In some such embodiments, upon receiving input from the consumer to save the offer, a computing device of the consumer can be directed to an Internet service of the retailer. In some such embodiments, the Internet service of the retailer is a website product page of a product of the offer.

In some embodiments, payment for the transmitted impression can be received from the awarded primary bidder, and payment for a conversion event can be received from the awarded secondary bidder. In some such embodiments, conversion event is one of: saving the offer, and redeeming the offer.

### DETAILED DESCRIPTION

### Overview

A user, such as a merchant or a marketer, managing a campaign of online marketing messages to consumers typically desires to receive feedback on the campaign. Given the variety of ways consumer reaction to a marketing message campaign can be characterized (most often as raw numbers), it is not always clear which characteristics are more significant than others.

In embodiments of the present technology, when an online advertising opportunity arises (for example when a consumer submits a query to a search engine), an online advertising system can receive bids from a set of primary bidders to present promotional content. The online advertising system can award the opportunity to a winning primary bidder. The online advertising system can then receive bids from secondary bidders for affiliation with the promotional content of the winning primary bidder. The online advertising system can award the affiliation opportunity to a winning secondary bidder. The online advertising system can then transmit the promotional content of the awarded primary bidder, as affiliated with the awarded secondary bidder, as an impression to a consumer during the online promotion opportunity. Upon receiving input from the consumer to save the offer, the online advertising system can associate the saved offer with a loyalty account of the consumer at the retailer affiliated with the online promotional content. The online advertising system can then direct a computing device of the consumer to an Internet service of the retailer. In some embodiments of the technology, payment for the transmitted impression can be received from the awarded primary bidder; and payment for a conversion event, such as saving the offer or redeeming the offer, can be received from the awarded secondary bidder.

While enabling embodiments are disclosed herein directed toward CPG manufacturers and retailers, the technology can find application in any situation where affiliation is applicable, including where the primary award is not by auction, but by other means such as contract to display coupon impressions between a web site operator and a manufacturer.

Turning now to the drawings, in which like numerals represent like (but not necessarily identical) elements throughout the figures, example embodiments of the present technology are described in detail.

### Example System Architectures

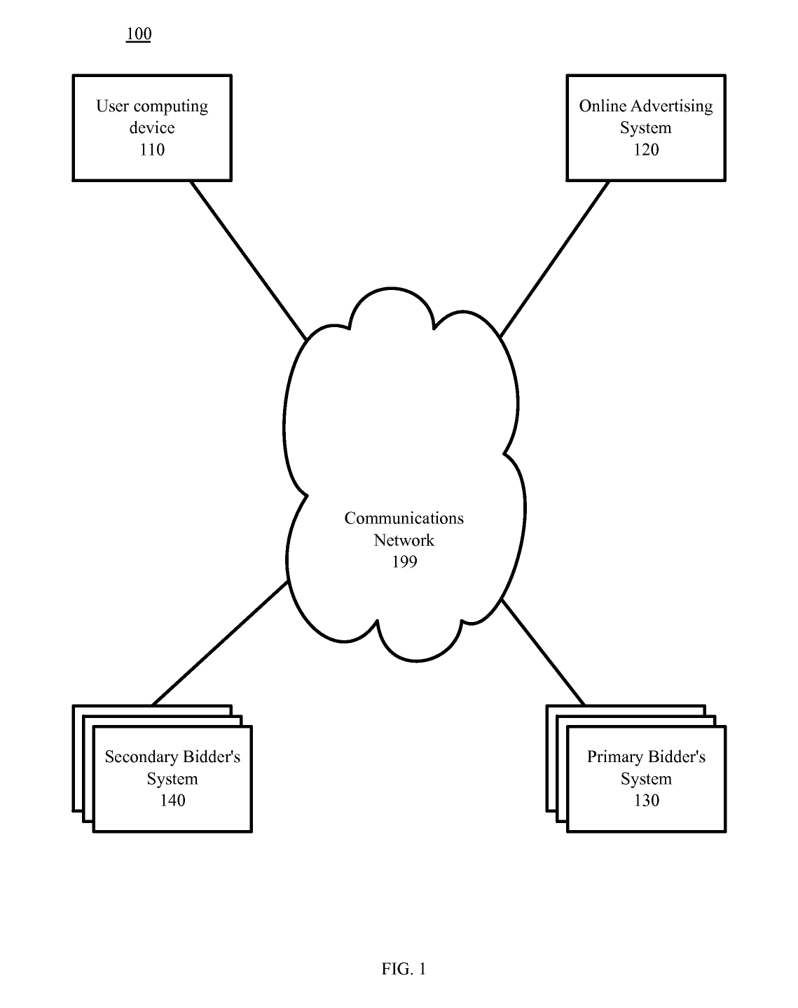

Referring to FIG. 1, an architecture for auctioning promotional item affiliation 100 is illustrated. While each server, system, and device shown in the architecture is represented by one instance of the server, system, or device, multiple instances of each can be used. Further, while certain aspects of operation of the present technology are presented as examples related to FIG. 1, additional features of the present technology are also disclosed elsewhere herein.

As depicted in FIG. 1, the architecture 100 includes network devices 110, 120, 130, and 140; each of which may be configured to communicate with one another via communications network 199. In some embodiments, a user associated with a device must install an application and/or make a feature selection via a network device to obtain the benefits of the technology described herein.

Network 199 includes one or more wired or wireless telecommunications means by which network devices may exchange data. For example, the network 199 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, a near field communication (NFC) connection, any combination thereof, and any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network device can include a communication module capable of transmitting and receiving data over the network 199. For example, each network device can include a server, a desktop computer, a laptop computer, a tablet computer, a television with one or more processors embedded therein and/or coupled thereto, a smart phone, a handheld computer, a personal digital assistant (PDA), or any other wired or wireless processor-driven device. In the example embodiment depicted in FIG. 1, a consumer may operate network device 110, an online advertising entity may operate online advertising system 120, a different primary bidder may operate each instance of primary bidder's system 130, and a different secondary bidder may operate each instance of secondary bidder's system 140.

The network connections illustrated are example and other means of establishing a communications link between the computers and devices can be used. Moreover, those having ordinary skill in the art having the benefit of the present disclosure will appreciate that the network devices illustrated in FIG. 1 may have any of several other suitable computer system configurations. For example, consumer computing device 110 may be embodied as a mobile phone or handheld computer may not include all the components described above.

### Example Methods

The example methods illustrated in the following figures are described hereinafter with respect to the components of the example operating environment and example architecture described elsewhere herein. The example methods may also be performed with other systems and in other environments.

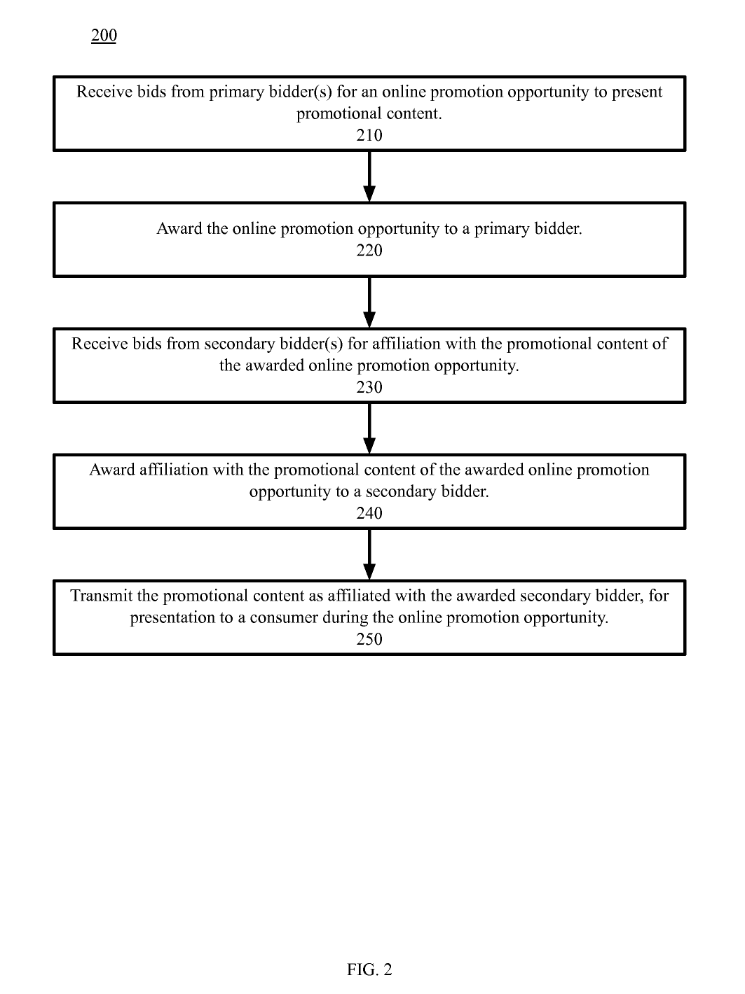

Referring to FIG. 2, and continuing to refer to FIG. 1 for context, methods 200 for auctioning promotional item affiliation in accordance with embodiments of the present technology are illustrated. In such embodiments, bids can be received from one or more primary bidders for an online promotional opportunity—Block 210. Promotional content, such as an advertisement or an offer, can be displayed online to a consumer in connection with such an opportunity.

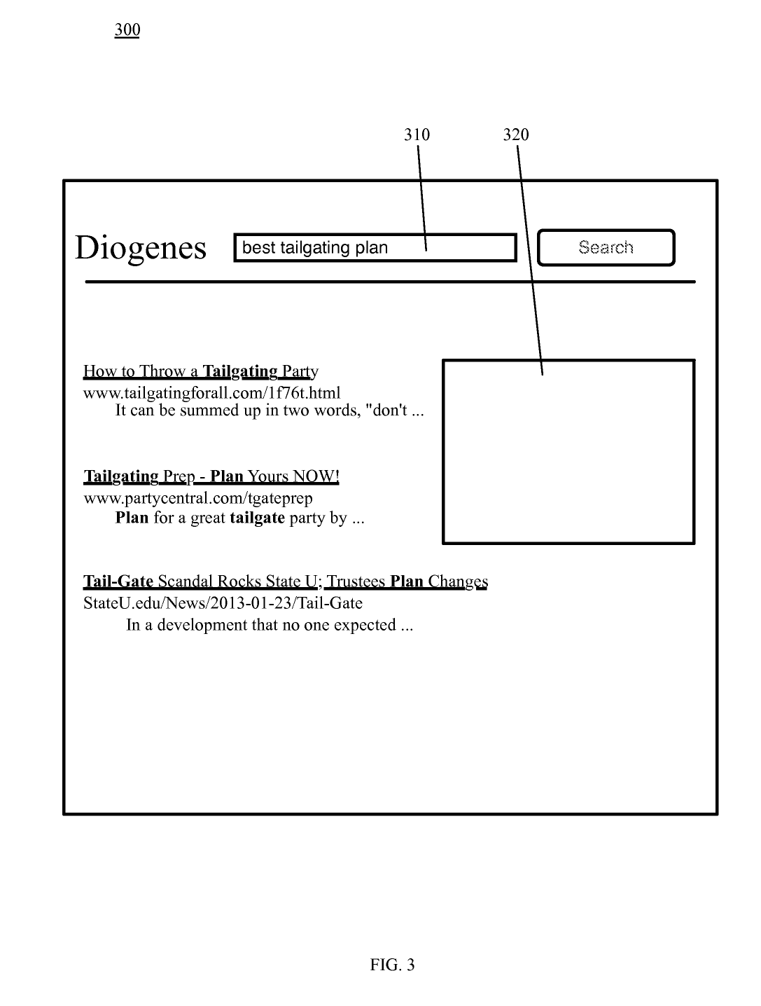

Consider, as part of a continuing example, separate campaigns set up by each of several CPG manufacturers for ad placement on search engine results pages. Each ad campaign specifies, inter alia, keywords, ad placement, and consumer characteristics that trigger a bid for a promotional opportunity to be displayed to the right of the search results in response to a consumer searches using a given search engine. For example, CPG manufacturers SnackCo, Tater Town, and United Salty Things each establish a campaign in which a consumer entering a query including the word “tailgating” triggers a bid. SnackCo's campaign includes ad content that is a manufacturer's electronic coupon for “$1 OFF any SnackCo product,” with a $10/100 redeemed coupons handling fee to the redeeming merchant. None of the coupons specify a retail outlet, that is, the coupons are each initially not co-branded. When a consumer enters “best tailgating plan,” an online advertising operator accepts a bid from each of SnackCo, Tater Town, and United Salty Things to place ad content in the promotional opportunity. Referring to FIG. 3, an example SERP 300 for the query “best tailgating plan” 310 is shown with a placeholder for the promotional opportunity 320.

While the continuing example relates to promotional opportunities on search engine results pages, embodiments of the technology also are applicable to promotional opportunities on web sites, in e-mail messages, in conjunction with text messages, and in other online advertising scenarios.

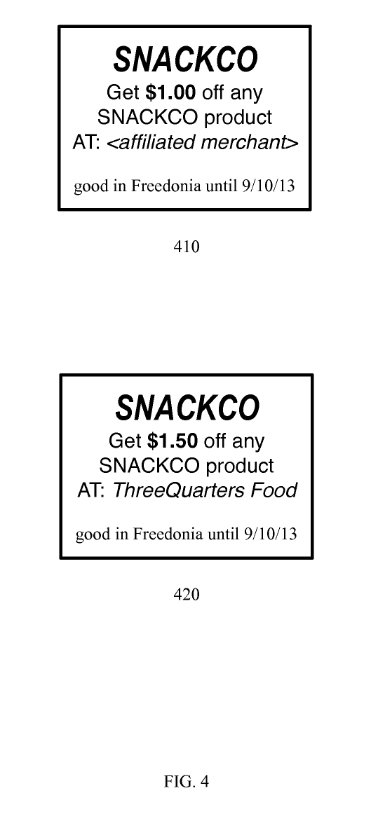

Embodiments of the present technology award the online promotion opportunity to a primary bidder based on primary auction logic—Block 220. For example, a composite score combining the bid value and promotional content quality can be used to determine the winning bid, with the winning bidder paying the amount bid value of the second highest bid. In the continuing example, SnackCo is awarded the opportunity to present the “$1 OFF any SnackCo product” electronic coupon to the right of the search results transmitted to the consumer in response to the consumer's “best tailgating plan” query. Referring to FIG. 4, an example coupon 410 is shown as described above with a placeholder for an affiliated secondary awarded bidder.

Before transmitting the promotional content of the awarded primary bidder, embodiments of the present technology can receive a bid from each of one or more secondary bidders for affiliation with the promotional content—Block 230. In the continuing example, before transmitting SnackCo's manufacturer electronic coupon in conjunction with search results in response to the consumer's query “best tailgating plan,” embodiments of the technology receive bids for affiliation with SnackCo's coupon from secondary bidders Food Tiger, Smuggler Sam's, and Three Quarter Food. Each secondary bidder offers the CPG of SnackCo to consumers, either at a retail location, or online. Each secondary bidder has set up a campaign to affiliate with promotional content related to certain products of certain CPG manufacturers. In some embodiments of the present technology, the campaign also can select characteristics of the promotional content, characteristics of the consumer, and characteristics of the query for which a secondary bid to affiliate with the promotional content of the primary bid is submitted. For example, Three Quarter Food's campaign specifies that it will not bid on affiliation with promotional content providing a manufacturer's discount under $1. As another example, Smuggler Sam's specifies submitting a secondary bid for affiliation with promotional content only where the primary bidder has offered a financial incentive to the affiliating secondary bidder for handling redemption. In the continuing example, SnackCo's promotional content meets both requirements.

In some embodiments, one or more secondary bidders can offer to enhance the promotional content item. In the continuing example, Three Quarter Food bids to increase the value of the coupon to the consumer by 50%, and Smuggler Sam's bids to extend the period for redemption by one month.

Embodiments of the present technology award the affiliation opportunity to a secondary bidder based on secondary auction logic—Block 240. In the continuing example, similar to the primary auction logic, a composite score combining bid value and promotional content quality can be used to determine the winning secondary bid, with the winning secondary bidder paying the amount bid value of the second highest secondary bid. In the continuing example, Three Quarter Food is awarded the opportunity to affiliate with the “$1 OFF any SnackCo product” electronic coupon to the right of the search results transmitted to the consumer in response to the consumer's “best tailgating plan” query.

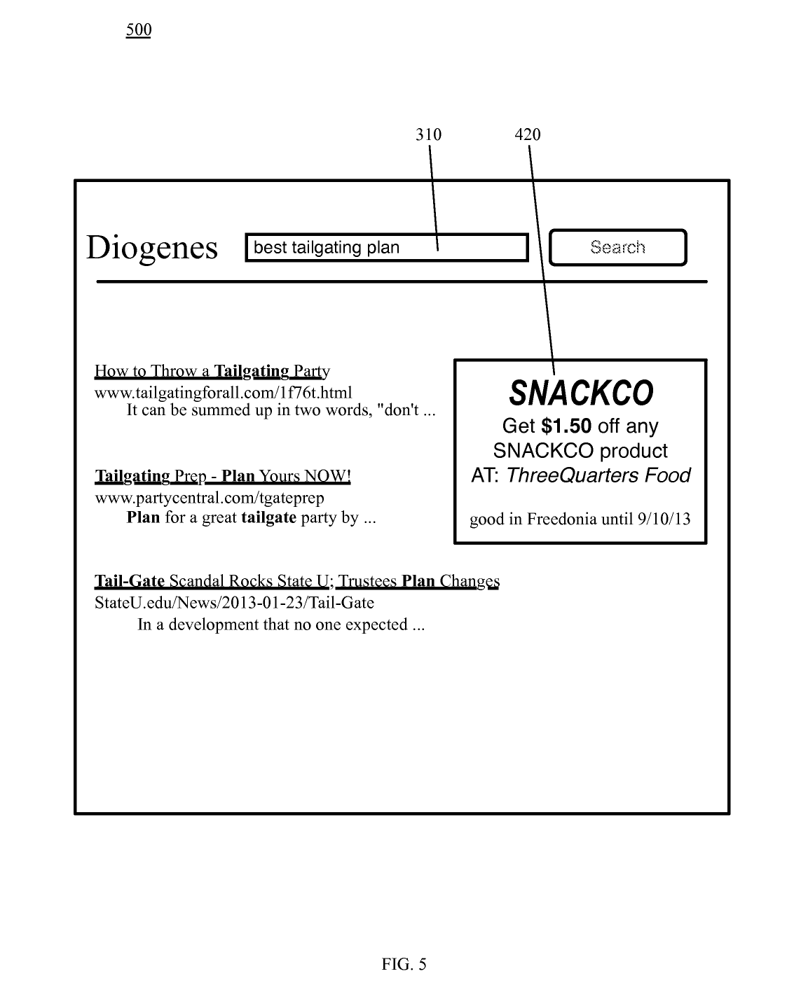

The promotional content can be transmitted in the promotion opportunity to the consumer as from the awarded primary bidder and as affiliated with the awarded secondary bidder—Block 250. In the continuing example, and referring to FIG. 5, SnackCo's “$1 off . . . ” coupon as modified by Three Quarter Food affiliation and 50% premium 410 is presented on the right side of SERP 500 is transmitted to the consumer in response to the query 310.

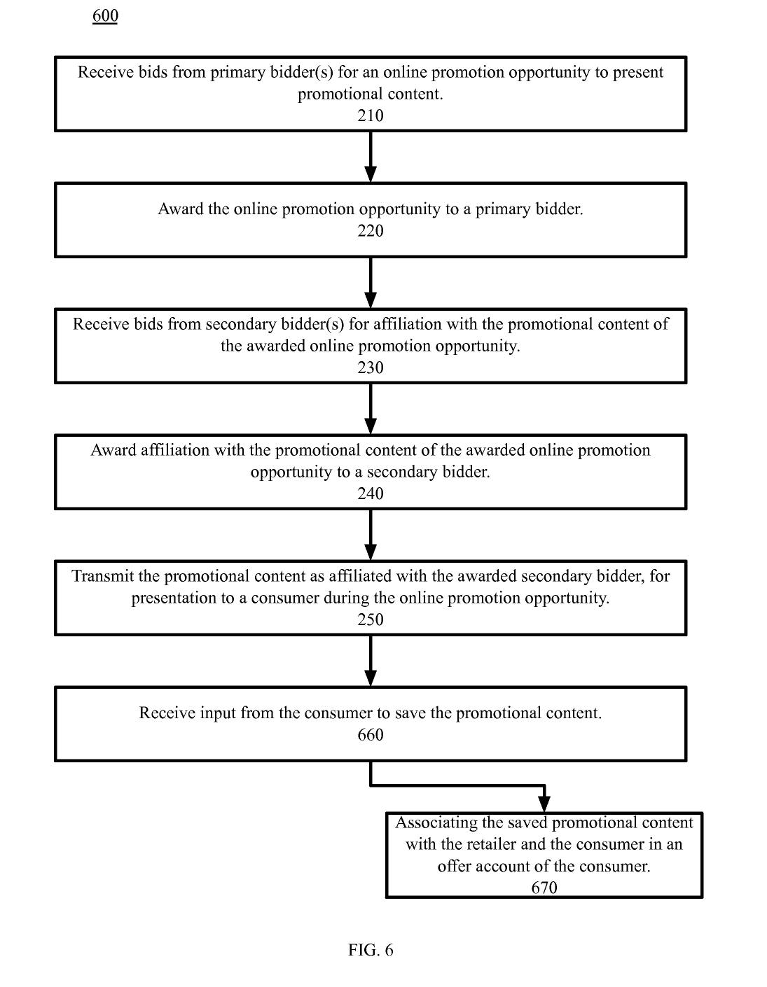

Referring to FIG. 6, and continuing to refer to prior figures for context, methods 600 for auctioning promotional item affiliation in accordance with embodiments of the present technology are illustrated. In such embodiments, Blocks 210-250 can be performed as described elsewhere herein. In such embodiments, after transmitting the promotion opportunity to the consumer as 1) from the awarded primary bidder, and 2) as affiliated with the awarded secondary bidder, some embodiments of the present technology can receive input from the consumer to save the promotional content—Block 660. In such embodiments, the promotional content can be associated with the retailer and the consumer in an account of the consumer—Block 670. In the continuing example, upon receiving input from the customer to save the SnackCo/Three Quarter Food offer, embodiments of the present technology can associate the saved offer in an electronic wallet of the consumer.

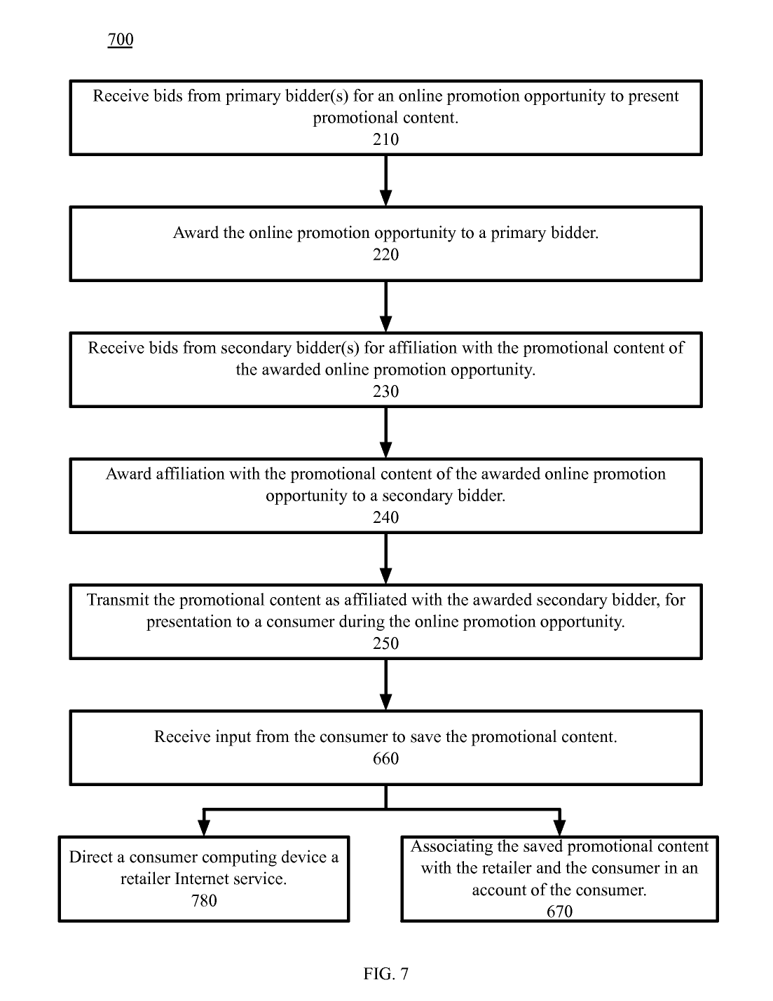

Referring to FIG. 7, and continuing to refer to prior figures for context, methods 700 for auctioning promotional item affiliation in accordance with embodiments of the present technology are illustrated. In such embodiments, Blocks 210-250, 660, and 670 can be performed as described elsewhere herein. In such embodiments, after receiving input from the consumer to save the promotional content, embodiments of the present technology will direct a computing device of the consumer to an Internet service of the affiliating retailer—Block 780. In the continuing example, an Internet browser in a computing device 110 of the consumer can be directed to the retailer's web site. In some embodiments, input other than a direction to save the offer, for example, selection of a hyperlink for more information or other such conversion activity, will direct the consumer computing device to an Internet service of the affiliating retailer.

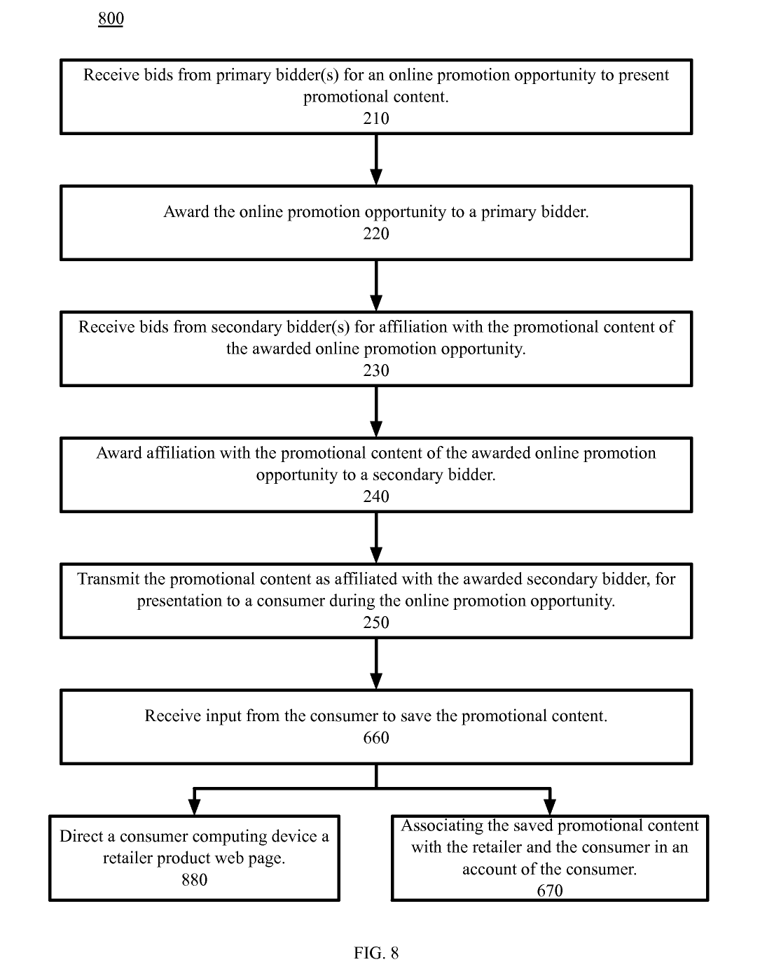

Referring to FIG. 8, and continuing to refer to prior figures for context, methods 800 for auctioning promotional item affiliation in accordance with embodiments of the present technology are illustrated. In such embodiments, Blocks 210-250, 660, and 670 can be performed as described elsewhere herein. In such embodiments, after receiving input from the consumer to save the promotional content, embodiments of the present technology will direct a computing device of the consumer to web page of the affiliating retailer for the offered product—Block 780.

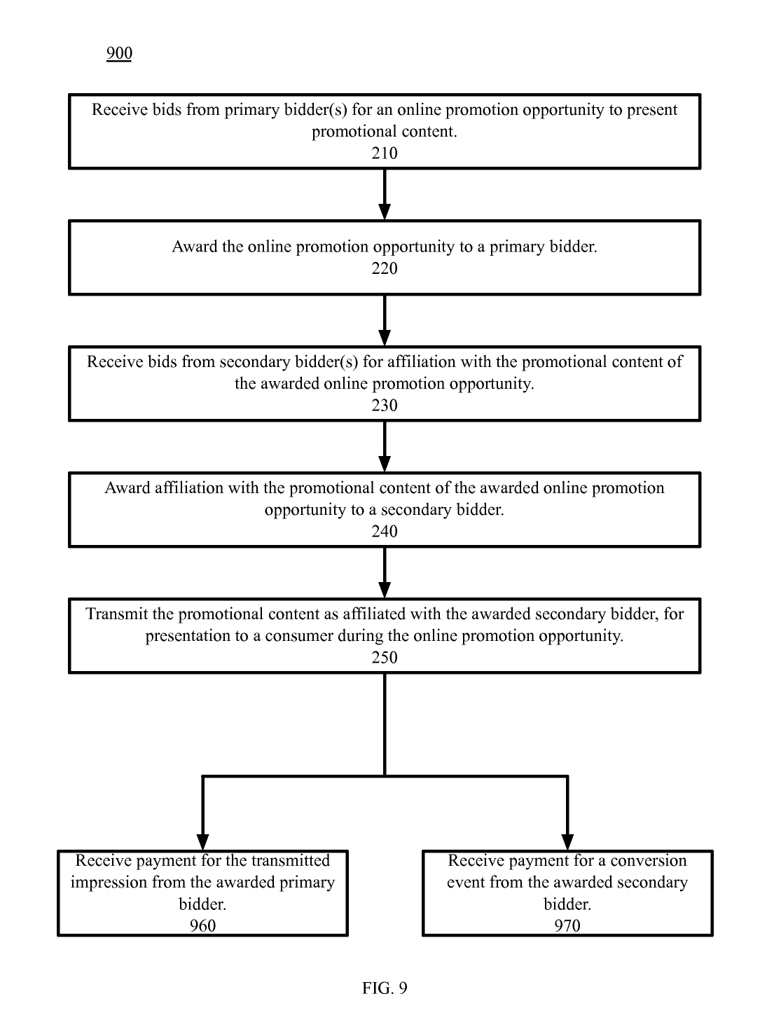

Referring to FIG. 9, and continuing to refer to prior figures for context, methods 900 for auctioning promotional item affiliation in accordance with embodiments of the present technology are illustrated. In such embodiments, Blocks 210-250 can be performed as described elsewhere herein. In such embodiments, after transmitting the promotion opportunity to the consumer as 1) from the awarded primary bidder, and 2) as affiliated with the awarded secondary bidder, some embodiments of the present technology can receive payment for the transmitted impression from the awarded primary bidder (Block 960), and receive payment for a conversion event from the awarded secondary bidder (Block 970). In the continuing example, upon transmitting the impression of the SnackCo/Three Quarter Foods coupon, SnackCo's advertising campaign account can be charged at the awarded primary bid rate. After receiving a click-through (a simple conversion) on the coupon, Three Quarter Foods advertising campaign account cam be charged at the awarded secondary bid rate.

### Other Example Embodiment

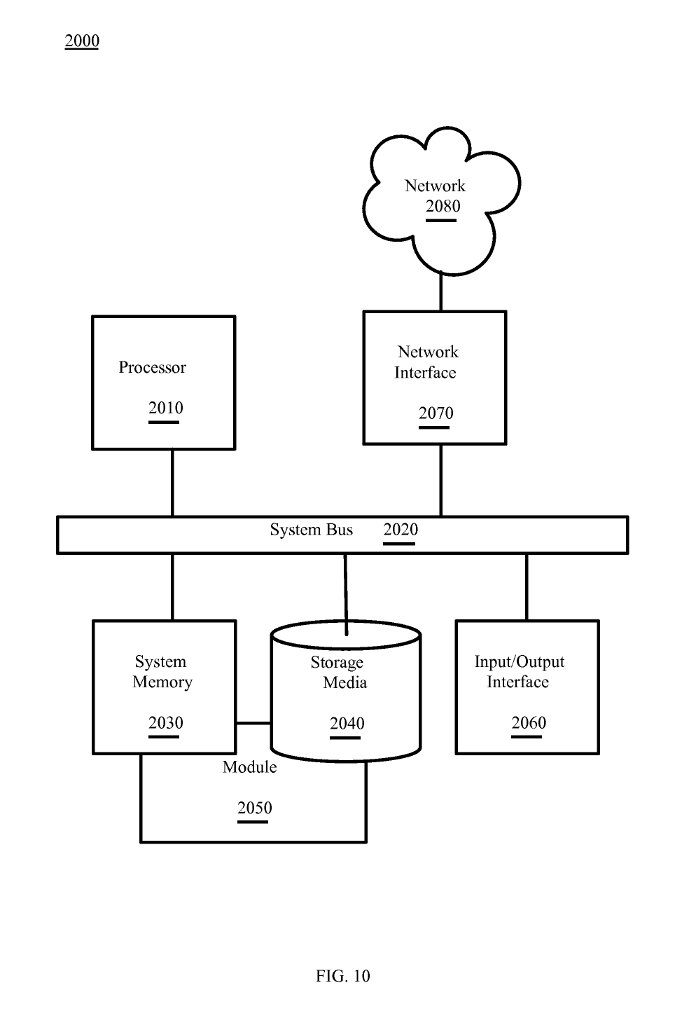

FIG. 10 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components, for example, a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories, for example, read-only memory (ROM), programmable read-only memory (PROM), erasable programmable read-only memory (EPROM), flash memory, or any other device capable of storing program instructions or data with or without applied power. The system memory 2030 may also include volatile memories, for example, random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device, for example, the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules, for example, module 2050, data, or any other information. The storage media 2040 may be part of, or connected to, the computing machine 2000. The storage media 2040 may also be part of one or more other computing machines that are in communication with the computing machine 2000, for example, servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits, for example, microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, for example, small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media, for example, fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device, for example, a system on chip (SOC), system on package (SOP), or ASIC device.

In situations in which the technology discussed here collects personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (, for example, to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the technology described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to present multiparty content online, comprising:
receiving, by one or more computing devices, at least one bid for a primary online promotion opportunity to present primary content, each bid for the primary online promotion opportunity being associated with one of a set of primary bidders;
awarding, by the one or more computing devices, the primary online promotion opportunity to a primary bidder from the set of primary bidders;
receiving, by the one or more computing devices, at least one bid for a secondary online promotion opportunity to be affiliated with the awarded primary online promotion opportunity, each bid for the secondary online promotion opportunity being associated with one of a set of secondary bidders and secondary content;
awarding, by the one or more computing devices, the second online promotion opportunity affiliated with the awarded primary online promotion opportunity to a secondary bidder from the set of secondary bidders; and
transmitting, by the one or more computing devices, the primary promotional content of the awarded primary bidder and the secondary content of the awarded secondary bidder, for presentation as a single item of content to a consumer, wherein the secondary content comprises an enhancement to the primary content.

2. The method of claim 1, wherein:
each primary bidder is a consumer package goods (CPG) manufacturer;
the primary content of the awarded primary bidder is an offer for CPG;
each secondary bidder is a retailer offering the CPG; and
the primary content includes a coupon characterized by a value, and the enhancement comprises an increased value.

3. The method of claim 2, further comprising:
receiving, by the one or more computing devices, input from the consumer to save the offer; and
associating, by the one or more computing devices, the saved offer with the retailer and the consumer in an account of the consumer.

4. The method of claim 3, further comprising:
upon receiving input from the consumer to save the offer, directing, by the one or more computing devices, a computing device of the consumer to an Internet service of the retailer.

5. The method of claim 4, wherein the Internet service of the retailer is a web site product page of a product of the offer.

6. The method of claim 1, further comprising:
receiving, by the one or more computing devices, payment associated with the online promotion opportunity from the awarded primary bidder, and
receiving, by the one or more computing devices, payment for a conversion event from the awarded secondary bidder.

7. The method of claim 6, wherein the conversion event is one of: saving the offer, and redeeming the offer.

8. A computer program product comprising:
a non-transitory computer-readable storage device having computer-executable program instructions embodied thereon that when executed by a computer cause the computer to present multiparty content online, the computer-executable program instructions comprising computer-executable program instructions to:
receive at least one bid for an online promotion opportunity to present primary content, each bid for the online promotion opportunity being associated with one of a set of primary bidders;
award the online promotion opportunity to a primary bidder from the set of primary bidders;
receive at least one bid for affiliation with the awarded online promotion opportunity, each bid for affiliation being associated with secondary content of one of a set of secondary bidders;
award affiliation with the awarded online promotion opportunity to a secondary bidder from the set of secondary bidders; and
transmit the primary content of the awarded primary bidder as affiliated with the secondary content of the awarded secondary bidder, for presentation to a consumer as a single item of content during the online promotion opportunity, wherein the secondary content comprises an enhancement to the primary content.

9. The computer program product of claim 8, wherein:
each primary bidder is a consumer package goods (CPO) manufacturer;
the primary content of the awarded primary bidder is an offer for CPO;
each secondary bidder is a retailer offering the CPO; and
the primary content includes a coupon characterized by a value, and the enhancement comprises an increased value.

10. The computer program product of claim 9, further comprising computer-executable program instructions to:
receive input from the consumer to save the offer; and
associate the saved offer with the retailer and the consumer in an account of the consumer.

11. The computer program product of claim 10, further comprising computer-executable program instructions to, upon receiving input from the consumer to save the offer, direct a computing device of the consumer to an Internet service of the retailer.

12. The computer program product of claim 11, wherein the Internet service of the retailer is a website product page of a product of the offer.

13. The computer program product of claim 8, further comprising computer-executable program instructions to:
receive payment associated with the online promotion opportunity from the awarded primary bidder, and
receive payment for a conversion event from the awarded secondary bidder.

14. The computer program product of claim 13, wherein the conversion event is one of:
saving the offer, and redeeming the offer.

15. A system to present multiparty content online, the system comprising:
a storage device; and
a processor communicatively coupled to the storage device, wherein the processor executes application code instructions that are stored in the storage device and that cause the system to:
receive at least one bid for an online promotion opportunity to present primary content, each bid for the online promotion opportunity being associated with one of a set of primary bidders;
award the online promotion opportunity to a primary bidder from the set of primary bidders;
receive at least one bid for affiliation with the awarded online promotion opportunity, each bid for affiliation being associated with secondary content of one of a set of secondary bidders;
award affiliation with the awarded online promotion opportunity to a secondary bidder from the set of secondary bidders; and
transmit the primary content of the awarded primary bidder as affiliated with the secondary content of the awarded secondary bidder, for presentation to a consumer as a single item of content during the online promotion opportunity, wherein the secondary content comprises an enhancement to the primary content.

16. The system of claim 15, wherein:
each primary bidder is a consumer package goods (CPO) manufacturer;
the primary content of the awarded primary bidder is an offer for CPO;
each secondary bidder is a retailer offering the CPO; and
the primary content includes a coupon characterized by a value, and the enhancement comprises an increased value.

17. The system of claim 16, further comprising application code instructions that are stored in
the storage device and that cause the system to:
receive input from the consumer to save the offer; and
associate the saved offer with the retailer and the consumer in an account of the consumer.

18. The system of claim 17, further application code instructions that are stored in the storage device and that cause the system to, upon receiving input from the consumer to save the offer, direct a computing device of the consumer to an Internet service of the retailer.

19. The system of claim 18, wherein the Internet service of the retailer is a website product page of a product of the offer.

20. The system of claim 15, further comprising application code instructions that are stored in the storage device and that cause the system to:
receive payment associated with the online promotion opportunity from the awarded primary bidder, and
receive payment for a conversion event from the awarded secondary bidder.
